(19) United States
(12) Patent Application Publication
(10) Pub. No.: US 2026/0162187 A1
(43) Pub. Date: Jun. 11, 2026

(54) ONLINE PROCESSING METHOD AND DEVICE

(71) Applicant: Alipay (Hangzhou) Digital Service Technology Co., Ltd., Hangzhou (CN)

(72) Inventors: Dong HAN, Hangzhou (CN); Ting TANG, Hangzhou (CN); Wenbin QIU, Hangzhou (CN)

(21) Appl. No.: 19/414,442

(22) Filed: Dec. 10, 2025

(30) Foreign Application Priority Data
Dec. 11, 2024 (CN) 202411824688.5

(51) Int. Cl. G06Q 40/08

(52) U.S. Cl. CPC G06Q 40/09

(57) ABSTRACT

An online processing method includes: generating a surrender interaction webpage based on a surrender request submitted by a user terminal for an insurance product, and returning the surrender interaction webpage to the user terminal; determining a prediction parameter for surrender quote prediction in insured-user data and policy data based on a product type of the insurance product; and inputting the prediction parameter into a prediction model corresponding to the product type for surrender quote prediction, to obtain a surrender loss range and return the surrender loss range to the user terminal.

### CROSS-REFERENCE TO RELATED APPLICATIONS

This application claims priority to Chinese Patent Application No. 202411824688.5, filed on Dec. 11, 2024, the entire content of which is incorporated herein by reference

### TECHNICAL FIELD

This specification relates to the field of data processing technologies, and in particular, to an online processing method and device.

### BACKGROUND

With continuous development and popularization of the Internet, related services, such as online insurance, online surrender, and online claims, of Internet-based insurance products become more popular. In this case, Internet insurance product services not only improve service efficiency and accuracy, but also bring great convenience to users. However, with continuous improvement to service experience requirements of the users, how to quickly and accurately provide related information of the insurance product services for the users and how to improve user experience have become important.

### SUMMARY

According to a first aspect of this specification, a method for online processing includes: generating a surrender interaction webpage based on a surrender request submitted by a user terminal for an insurance product, and returning the surrender interaction webpage to the user terminal; determining a prediction parameter for surrender quote prediction in insured-user data and policy data based on a product type of the insurance product; and inputting the prediction parameter into a prediction model corresponding to the product type for surrender quote prediction, to obtain a surrender loss range and return the surrender loss range to the user terminal.

According to a second aspect of this specification, a method for online processing includes: generating a surrender request for an insurance product, and submitting the surrender request to a server; displaying a surrender interaction webpage returned by the server for the insurance product; and obtaining and displaying a surrender loss range that is obtained through surrender quote prediction and that is returned by the server, where the surrender quote prediction is performed by inputting a prediction parameter determined in user data and policy data of an insured user into a prediction model corresponding to a product type of the insurance product.

According to a third aspect of this specification, a device for online processing includes: a processor, and a storage configured to store computer-executable instructions. The processor is configured to: generate a surrender interaction webpage based on a surrender request submitted by a user terminal for an insurance product, and return the surrender interaction webpage to the user terminal; determine a prediction parameter for surrender quote prediction in insured-user data and policy data based on a product type of the insurance product; and input the prediction parameter into a prediction model corresponding to the product type for surrender quote prediction, to obtain a surrender loss range and return the surrender loss range to the user terminal.

According to a fourth aspect of this specification, a device for online processing includes: a processor, and a storage configured to store computer-executable instructions. The processor is configured to: generate a surrender request for an insurance product, and submit the surrender request to a server; display a surrender interaction webpage returned by the server for the insurance product; and obtain and display a surrender loss range that is obtained through surrender quote prediction and that is returned by the server, where the surrender quote prediction is performed by inputting a prediction parameter determined in user data and policy data of an insured user into a prediction model corresponding to a product type of the savings-type insurance product.

### BRIEF DESCRIPTION OF DRAWINGS

The following is a brief introduction of the accompanying drawings of this specification. Clearly, embodiments illustrated in the accompanying drawings are merely example embodiments of this specification.

FIG. 1 is a schematic diagram of an implementation environment of an online processing method according to one or more embodiments.

FIG. 2 is a flowchart of an online processing method according to one or more embodiments.

FIG. 3 is a schematic diagram of a surrender interaction page according to one or more embodiments.

FIG. 4 is a schematic diagram of a processing page according to one or more embodiments.

FIG. 5 is a schematic diagram of a surrender confirmation page according to one or more embodiments.

FIG. 6 is a flowchart of an online processing method applied to a surrender scenario according to one or more embodiments.

FIG. 7 is a flowchart of an online processing method according to one or more embodiments.

FIG. 8 is a schematic diagram of an online processing apparatus according to one or more embodiments.

FIG. 9 is a schematic diagram of an online processing apparatus according to one or more embodiments.

FIG. 10 is a schematic diagram of an online processing device according to one or more embodiments.

FIG. 11 is a schematic diagram of an online processing device according to one or more embodiments.

### DETAILED DESCRIPTION OF EMBODIMENTS

The following describes example embodiments of this specification with reference to the accompanying drawings. Clearly, the described embodiments are merely some rather than all of embodiments of this specification. All other embodiments obtained by a person of ordinary skill in the art based on the described embodiments of this specification without making innovative efforts shall fall within the protection scope of this specification.

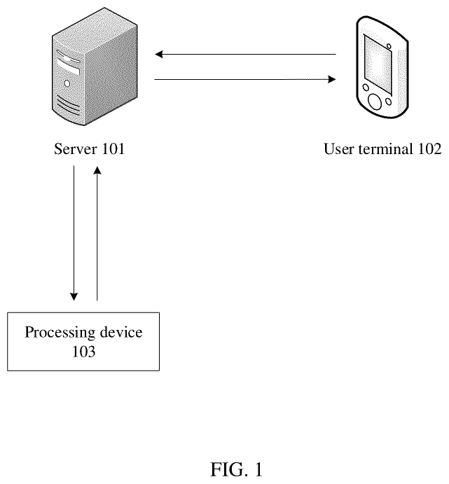

FIG. 1 is a schematic diagram of an implementation environment of an online processing method according to one or more embodiments. As shown in FIG. 1, the implementation environment includes a server 101, a user terminal 102, and a processing device 103, e.g., of an insurance institution.

The server 101 can be one or more servers, a server cluster including several servers, or a cloud server of a cloud computing platform. An interactive robot can be deployed on the server 101. The server 101 is configured to: interact with the user terminal 102, receive a surrender request submitted by the user terminal 102, and return a surrender interaction page and a surrender loss range obtained through surrender quote prediction to the user terminal. In this specification, a page, such as the surrender interaction page, is a webpage generated by an electronic device, such as a server.

The user terminal 102 can be a smartphone, a tablet computer, an e-book reader, a wearable device, a device that performs information exchange based on augmented reality (AR)/virtual reality (VR), etc., and can further be installed with an application program and/or a browser, to submit the surrender request and display the surrender interaction page by using the application program and/or the browser. The user terminal 102 is configured to: submit the generated surrender request to the server 101, receive the surrender interaction page returned by the server 101, and display the surrender loss range.

The processing device 103 can perform surrender quote calculation after receiving a surrender quote interface call request submitted by the server 101, and send a surrender quote result to the server 101. The processing device 103 can further perform surrender processing and return a corresponding surrender amount to the server 101 after receiving the surrender request submitted by the server 101.

In this implementation environment, in an online processing process, the user terminal 102 generates a surrender request for an insurance product, such as a savings-type insurance product, and submits the surrender request to the server 101. The server 101 sends, based on the surrender request submitted by the user terminal 102, surrender quote processing to the processing device 103 by calling a surrender quote interface of the insurance product in an asynchronous manner, and generates a surrender interaction page and returns the surrender interaction page to the user terminal 102. The user terminal 102 receives and displays the surrender interaction page returned by the server 101 for the savings-type insurance product. After a user triggers a surrender quote question in an interaction question on the surrender interaction page or asks a question that includes a quote keyword, the user terminal 102 submits question information to the server 101. After receiving the question information, the server 101 determines a prediction parameter for surrender quote prediction in insured-user data and policy data based on a product type of the savings-type insurance product; and inputs the prediction parameter into a prediction model corresponding to the product type for surrender quote prediction, to obtain a surrender loss range and return the surrender loss range to the user terminal 102. The user terminal 102 obtains and displays the surrender loss range returned by the server 101, so that the user obtains the surrender loss prediction. After receiving a surrender quote result returned by the processing device 103 of the insurance institution, the server 101 generates a surrender confirmation page based on the surrender quote result, and returns the surrender confirmation page to the user terminal 102 after receiving a surrender confirmation instruction submitted by the user terminal 102. The user terminal 102 displays the surrender confirmation page to the user. If the user terminal 102 submits a surrender instruction to the server 101, the server 101 performs surrender processing and returns a corresponding surrender amount to a user account, so that the user implements surrender.

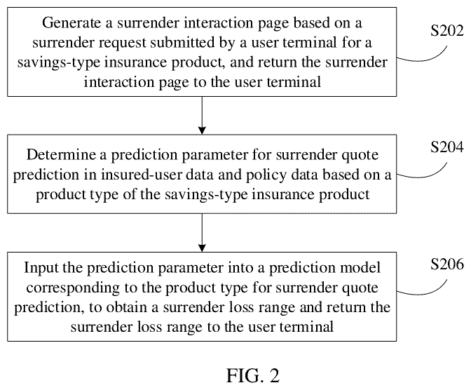

FIG. 2 is a flowchart of an online processing method according to one or more embodiments. For example, the online processing method can be applied to a server, and can include step S202 to step S206.

Step S202: Generate a surrender interaction page based on a surrender request submitted by a user terminal for an insurance product, such as a savings-type insurance product, and return the surrender interaction page to the user terminal.

For example, the savings-type insurance product combines a saving and an insurance function and provides certain insurance while providing fund accumulation for a user. The user can regularly pay a premium, a part of the paid premium can be deposited into a savings account of the user, and the user can choose to withdraw such funds after a specified period. In addition, if an agreed risk event occurs within a coverage period, the user can obtain corresponding funds paid by an insurance company based on an agreement.

Savings-type insurance products can have a plurality of product types that can include a savings-type insurance product of a savings type, a savings-type insurance product of a dividends type, a savings-type insurance product of a floating income type, etc.

In an embodiment, after the user joins the savings-type insurance product, the user can choose to exit the savings-type insurance product. That the user exits the savings-type insurance product is referred to as surrender. For the savings-type insurance product, after the user requests surrender, a certain amount of funds need to be returned to the user. Specifically, a process of calculating funds to be returned to the user is referred to as surrender quote.

After the user chooses to exit the savings-type insurance product, the user can submit a surrender request. The surrender request is a request that the user applies to the insurance institution to exit the savings-type insurance product. The surrender interaction page is a user page that interacts with the user in a surrender process.

In specific implementations, in the surrender process, the user terminal can generate and submit the surrender request for the savings-type insurance product. Herein, after the surrender request submitted by the user terminal is obtained, the surrender interaction page is generated in response to the surrender request submitted by the user terminal, and the generated surrender interaction page is returned to the user terminal. After the surrender interaction page is returned, the user terminal can display the surrender interaction page to the user.

For example, in a process of generating the surrender interaction page, to improve a response speed and efficiency of an interaction process, a processing module that is specifically used to perform interaction in the surrender process of the insurance product can be further configured. For example, interaction processing can be performed by using an interactive robot. Herein, the surrender interaction page can also be generated by the interactive robot.

In an embodiment, the method is applied to an interactive robot that performs surrender interaction processing on the insurance product. The surrender interaction page includes a surrender interaction page generated by the interactive robot for the savings-type insurance product.

The surrender interaction page can include any one or more elements in an interaction question, a question and answer interaction control, and/or a surrender control. For example, the surrender interaction page can include the interaction question, and the interaction question can be preset, to guide the user to understand a surrender procedure and related information. The surrender interaction page can further include the question and answer interaction control, so that the user can enter a surrender-related question and obtain a corresponding feedback and answer. The surrender interaction page can further include a surrender control, so that the user can perform a specific surrender operation. In an embodiment, the surrender interaction page includes the interaction question, the question and answer interaction control, and/or the surrender control.

In a specific execution process, after the surrender interaction page is generated and returned to the user terminal, the user terminal can display the surrender interaction page, so that the user can learn about a surrender-related procedure and information on the surrender interaction page. To improve efficiency of surrender processing and provide the user with an accurate and detailed answer to the surrender-related question, in an implementation, after the surrender interaction page is generated based on the surrender request submitted by the user terminal for the savings-type insurance product, and returned to the user terminal, the method further includes: inputting the interaction question submitted by the user terminal into a large language model for answer generation, to obtain an interaction answer; and returning the interaction answer to the user terminal, to display the interaction answer in the question and answer interaction control.

For example, after the surrender interaction page is generated based on the surrender request and returned to the user terminal, the user can enter, on the surrender interaction page by using the question and answer interaction control, an interaction question that the user wants to understand. The interaction question can include aspects such as a specific process of surrender, a required material, and surrender amount estimation. The interaction question submitted by the user is received and parsed, and then the interaction question is input into a large language model. The large language model can analyze the interaction question of the user, generate a corresponding interaction answer, return the generated interaction answer to the user terminal, and display the interaction answer in the question and answer interaction control on the surrender interaction page, so that the user can further understand related information of surrender based on the interaction answer.

In a specific execution process, to improve accuracy of a surrender result and enable the user to obtain accurate surrender loss information, after the surrender interaction page is generated and returned to the user terminal, whether a processing institution has a value calculation rule that can be directly used to calculate a surrender loss can be first detected. In an implementation, after the surrender interaction page is generated based on the surrender request submitted by the user terminal for the savings-type insurance product, and returned to the user terminal, and before the prediction parameter for surrender quote prediction is determined in the insured-user data and the policy data based on the product type of the savings-type insurance product, the method further includes: detecting whether a processing institution stores a value calculation rule for savings-type insurance product; and if no, performing step S204 of determining a prediction parameter for surrender quote prediction in insured-user data and policy data based on a product type of the savings-type insurance product.

In this case, the value calculation rule is a predefined rule used to calculate a policy cash value and/or a surrender loss of the savings-type insurance product. The value calculation rule can be used to calculate a precise surrender loss range, that is, a surrender loss actually returned to the user.

For example, after the surrender interaction page is generated, whether the processing institution stores the value calculation rule of the savings-type insurance product can be first detected. If a detection result is that the processing institution does not store the value calculation rule of the savings-type insurance product, it indicates that the prestored calculation rule cannot be directly used to precisely calculate the surrender loss of the savings-type insurance product, and step S204 needs to be performed to predict the surrender loss range. Step S204 is specifically: determining the prediction parameter for the surrender quote prediction based on the product type of the savings-type insurance product, to further obtain a predicted surrender loss range.

In addition, if the detection result is that the processing institution stores the value calculation rule of the savings-type insurance product, it indicates that the prestored calculation rule can be used to precisely calculate the surrender loss of the savings-type insurance product. In this case, the following optional implementation can be used to obtain the precise surrender loss range.

In an implementation, if a result obtained by detecting whether the processing institution stores the value calculation rule for the savings-type insurance product is yes, the following operations are performed: querying a surrender calculation parameter in the value calculation rule based on the insured-user data and the policy data; and inputting the surrender calculation parameter into a surrender loss algorithm for surrender loss calculation, to obtain the surrender loss range.

For example, if the detection result is that the processing institution stores the value calculation rule of the savings-type insurance product, the insured-user data and the policy data can be first obtained from the surrender request of the user, and then the surrender calculation parameter is quired in the value calculation rule based on the insured-user data and the policy data. The surrender calculation parameter can be shown in Table 1. Then, a specific value and a calculation method that are related to the surrender calculation parameter can be extracted from the prestored value calculation rule, and the surrender calculation parameter is input into the surrender loss algorithm for surrender loss calculation, to obtain the surrender loss range.

TABLE 1

| Parameter | | |
|---|---|---|
| type | Parameter value/meaning | Specific value |
| Policy year | Current policy year, integer | x |
| Date of birth | Date of birth of an insured | xx (month) xx (day), |
| | person | xxxx (year) |
| User type | Insured-user type | 1: Male 2: Female |
| Payment | Payment frequency | 01: Lump-sum payment 02: |
| method | | Monthly payment |
| | | 03: Annual payment 04: |
| | | Half-monthly payment |
| Payment | By year: nY; By date of | xY: Pay for x years |
| period | birth nA | XA: Pay until age X |
| Payout | By year: nY; By date of | xY: Payout for x years; |
| period | birth nA | xA: Payout until age X |
| Start payout | By year: nY; By date of | xY: Payout after x years; |
| period | birth nA | xA: Payout after age x; |
| Year-end | Calculate a current year-end | If the current year-end price |
| cash value | price based on a ratio | of each 1000 yuan premium is |
| | between a premium to the | 1500 yuan, and 10000 yuan is |
| | current year-end price | configured, the current year- |
| | | end price is 15000 yuan |

Further, to enable the user to understand a possible fund loss range during surrender, and provide reference information for the user to evaluate surrender impact, when a possible loss of the user during surrender is calculated based on the policy data and the surrender calculation parameter, a clear surrender loss range can be provided for the user. In an implementation, the surrender loss calculation includes: calculating a first loss amount between an accumulated insurance amount and a policy value of a coverage period including a current time, and calculating a second loss amount between the accumulated insurance amount and a policy value of a previous coverage period; and calculating ratios of the first loss amount and the second loss amount to the accumulated insurance amount as a loss upper limit and a loss lower limit of the surrender loss range.

In this process, a difference between the accumulated insurance amount and the policy value of the coverage period including the current time is calculated as the first loss amount, and a difference between the accumulated insurance amount and the policy value of the previous coverage period is calculated as the second loss amount; and then a ratio between the first loss amount and the accumulated insurance amount is used as the loss upper limit of the surrender loss range, and a ratio between the second loss amount and the accumulated insurance amount is used as the loss lower limit of the surrender loss range, to determine a specific surrender loss range.

For example, if the user insures on x (month) x (day), 2021 and surrenders on x (month) x (day), 2024, based on policy data such as a date of birth of an insured person, a user type, a payment method, a payment period, a payout period of the product, and a start payment period in a policy of the user, a current policy year is 4, and a cash value ratio at the end of the third policy year and a cash value ratio at the end of the fourth policy year can be obtained. Based on Surrender loss ratio=(Accumulated investment-Policy cash value)/Accumulated investment, surrender loss ratios x1 and x2 are calculated. The surrender loss ratio x1 can be used as the loss lower limit of the surrender loss range, and the surrender loss ratio x2 is used as the loss upper limit of the surrender loss range. In this case, a surrender loss of the user falls within a range is [x1, x2].

In addition, after the surrender interaction page is generated and returned to the user terminal, before the user enters the surrender interaction page or after the user enters the surrender interaction page, a mandatory option page or a mandatory option pop-up window can be further set and returned to the user terminal, so that the user terminal displays the mandatory option page or the mandatory option pop-up window. The mandatory option page or the mandatory option pop-up window can configure a mandatory option of the surrender-related question, for example, a surrender reason and a user requirement, or may not configure a mandatory option, but set the surrender-related question. The user can fill in or select based on an individual condition, to better understand the user requirement, to provide targeted content of the surrender interaction page based on a user selection.

Step S204: Determine a prediction parameter for surrender quote prediction in insured-user data and policy data based on a product type of the savings-type insurance product.

In an embodiment, after the user joins the savings-type insurance product, the user can choose to exit the savings-type insurance product. After the user requests surrender, a certain amount of funds need to be returned to the user. A process of calculating funds to be returned to the user, a possible loss of the user, etc. is referred to as surrender quote.

As described above, the savings-type insurance product can have three product types. In a surrender quote prediction process, prediction parameters required for savings-type insurance products of different product types may be different. Herein, a corresponding prediction parameter can be determined based on the product type of the savings-type insurance product, the insured-user data, and the policy data, to perform further surrender quote prediction.

In the specific execution process, to improve accuracy of a surrender quote prediction result, and improve flexibility and adaptability of the surrender quote prediction process, proper prediction parameters can be selected based on different product types of the savings-type insurance product. In an implementation, determining the prediction parameter for surrender quote prediction in the insured-user data and the policy data based on the product type of the savings insurance product includes: reading each prediction parameter type in a prediction parameter table of the product type; and querying a prediction parameter corresponding to each prediction parameter type in the insured-user data and the policy data.

The prediction parameter type is a predefined parameter type based on a type, content, etc. of the savings-type insurance product, and can include a policy year, a birth date of an insured person, a user type, a payment frequency, a payment period, a payment period, a payout period, a start payout period, etc.

For example, in a process of determining the prediction parameter for the surrender quote prediction, each prediction parameter type can be read from a prediction parameter table corresponding to the product type of the savings-type insurance product; and then a prediction parameter corresponding to each prediction parameter type is queried in the insured-user data and the policy data, and surrender quote prediction is performed based on the found prediction parameter.

For example, Table 2 shows a prediction parameter table of a savings-type insurance product of a savings type. A specific prediction parameter corresponding to each prediction parameter type such as a policy year, a user type, a payment frequency, a payment period, a payout period, a start payout period, and a surrender loss range can be found in the prediction parameter table, and the found prediction parameter is input into a corresponding prediction model for surrender quote prediction.

TABLE 2

| | | | | | Start | |
|---|---|---|---|---|---|---|
| Policy | User | Payment | Payment | Payout | Payout | Surrender loss |
| year | type | frequency | period | period | period | range |
| 7 | 1 | 01 | NA | 5 Y | 20 Y | No loss |
| 6 | 1 | 01 | NA | 5 Y | 20 Y | 0-5% |
| 5 | 1 | 01 | NA | 5 Y | 20 Y | |
| 4 | 1 | 01 | NA | 5 Y | 20 Y | 5%-10% |
| 4 | 1 | 01 | NA | 5 Y | 20 Y | |
| 3 | 1 | 01 | NA | 5 Y | 20 Y | 10%-20% |
| 2 | 1 | 01 | NA | 5 Y | 20 Y | 30%-50% |
| 2 | 1 | 01 | NA | 5 Y | 20 Y | |
| 1 | 1 | 01 | NA | 5 Y | 20 Y | More than 50% |
| 1 | 1 | 01 | NA | 5 Y | 20 Y | |

Step S206: Input the prediction parameter into a prediction model corresponding to the product type for surrender quote prediction, to obtain a surrender loss range and return the surrender loss range to the user terminal.

The prediction model in this embodiment is configured to predict, based on the insured-user data and the policy data of the user and based on a specific product type and a value calculation rule of the savings insurance product, a possibly obtained amount and a loss of the user during surrender. Corresponding models can be set for product types of different savings-type insurance products. For example, different models can be trained in a case of different prediction parameters, and the same model can be used in a case of similar prediction parameters. The prediction parameter determined from the insured-user data and the policy data can be input into the prediction model based on the product type of the savings-type insurance product. The surrender loss range is output. The surrender loss range includes a loss upper limit value and a loss lower limit value.

In an implementation, considering that different savings-type insurance products may have different calculation rules, to improve prediction accuracy, a corresponding prediction model can be first determined based on the product type of the savings-type insurance product, so that the prediction model matches a specific savings-type insurance product, and then the prediction parameter found from the insured-user data and the policy data is input into the corresponding prediction model for surrender quote prediction, to obtain an estimated surrender loss range, and the estimated surrender loss range is returned to the user terminal, so that the user learns of a surrender loss that may be faced.

In the specific execution process, after the user triggers a surrender quote question on the surrender interaction page, the user can perform surrender quote prediction, and return the predicted surrender loss range to the user terminal, to respond to the quote requirement of the user in a timely manner and provide the user with immediate surrender loss estimation. In an implementation, the surrender quote prediction is performed after the surrender quote question in the interaction question is triggered. The surrender loss range is displayed in the question and answer interaction control after being returned to the user terminal.

For example, after the user clicks or selects a specific question related to the surrender quote in the interaction question on the surrender interaction page, a corresponding instruction that is generated based on a trigger action of the user and that is submitted by the user terminal is received, and surrender quote prediction can be performed. Correspondingly, the surrender loss range obtained through surrender quote prediction can be returned to the user terminal, and displayed in the question and answer interaction control on the surrender interaction page.

In addition, the user can submit a question including a quote keyword on the surrender interaction page to trigger surrender quote prediction. In another optional implementation provided in this embodiment, the surrender quote prediction is performed after it is detected that the question information submitted by the user terminal includes the quote keyword. The surrender loss range is displayed in the question and answer interaction control after being returned to the user terminal.

For example, when it is detected that the user submits, in the question and answer interaction control on the surrender interaction page, question information that includes quote or a keyword with a similar meaning of the quote, etc., the surrender quote prediction can also be triggered. In addition, the returned surrender loss range can be displayed in the question and answer interaction control configured on the surrender interaction page of the user terminal, or a pop-up window or a page that includes the surrender loss range can be directly return to the user terminal, to display the surrender loss range to the user.

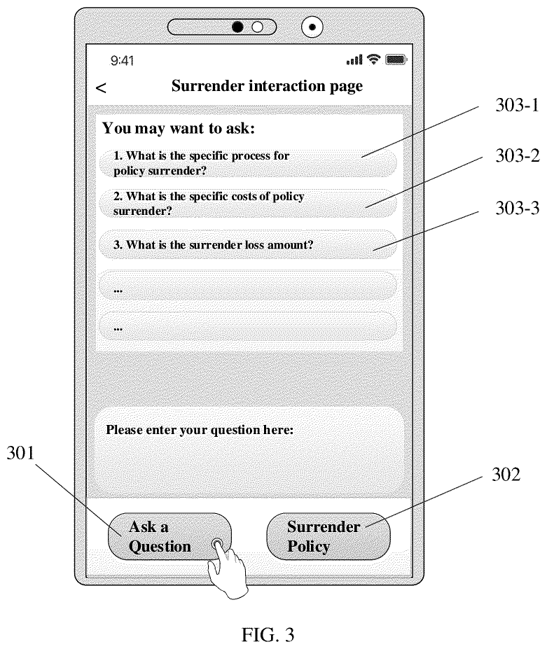

FIG. 3 is a schematic diagram of a surrender interaction page according to one or more embodiments. As shown in FIG. 3, the surrender interaction page can include a question and answer interaction control 301, a surrender control 302, interaction questions 303-1, 303-2, and 303-3, etc. The user can directly select, based on the displayed interaction questions, a question that the user wants to understand, or can click a question button in the question and answer interaction control, to input a question.

In an embodiment, in a process in which the user interacts on the surrender interaction page, if a question selected or entered by the user does not involve a surrender amount or loss estimation, or if the user directly triggers the surrender control to select surrender after entering the surrender interaction page, to enable the user to learn of a fund loss that may be faced in a case of surrender, surrender quote prediction can be performed, and a surrender loss range is returned to the user after the user triggers the surrender control.

In an implementation, the determining of the prediction parameter and the surrender quote prediction are performed after a surrender instruction generated by triggering the surrender control is received.

Correspondingly, a processing page that carries the surrender loss range is generated and returned to the user terminal, and a surrender confirmation instruction that is generated after the surrender control is triggered and that is configured on the processing page submitted by the user terminal is received.

For example, when the user does not select or ask, on the surrender interaction page, a question related to the surrender amount or loss estimation, but selects or asks a general question related to a surrender procedure and then triggers the surrender control; or the user does not perform interaction question-answering on the surrender interaction page, but directly trigger the surrender control, the surrender quote prediction can be performed after the user triggers the surrender control, and the processing page that carries the surrender loss range is returned to the user.

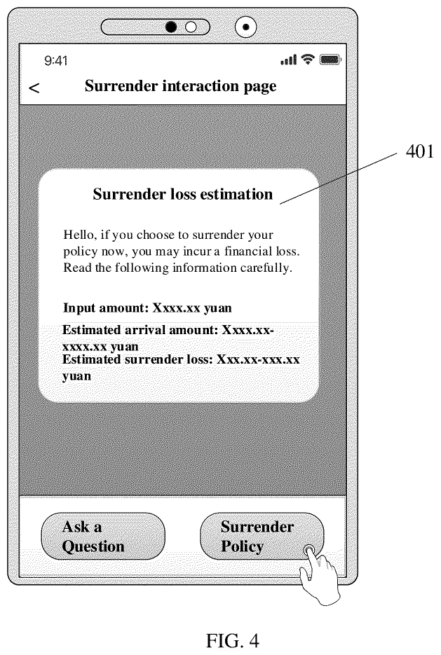

For example, after the user clicks the surrender control 302 shown in FIG. 3, surrender quote prediction can be performed based on the received surrender instruction generated by triggering the surrender control. FIG. 4 is a schematic diagram of a processing page according to one or more embodiments. Correspondingly, a pop-up window 401 that carries the surrender loss range shown in FIG. 4 or a processing page that carries the surrender loss range can be generated and returned to the user terminal, to display the predicted surrender loss range to the user.

In the specific execution process, to prevent the user from waiting too long time when accessing the surrender confirmation page, after the surrender request submitted by the user terminal for the savings-type insurance product is received, interaction question-answering is performed with a customer, and a surrender loss is estimated. In addition, the surrender confirmation page can be loaded asynchronously, so that the user learns of the surrender loss in advance, and a problem of a long page loading time of the surrender confirmation page is avoided. In an implementation, the method further includes: in response to the surrender request, calling, in an asynchronous manner, a surrender quote interface of the savings-type insurance product for surrender quote processing; and generating a surrender confirmation page based on a surrender quote result returned through an interface call, and returning the surrender confirmation page to the user terminal after receiving a surrender confirmation instruction.

For example, in response to the surrender request submitted by the user terminal, the surrender quote interface of the savings-type insurance product can be called in the asynchronous manner for surrender quote processing. That is, a response result of the surrender quote interface is not waited, but a surrender interaction page is returned to the user terminal, so that the user can continue to browse or perform another operation while waiting for the surrender confirmation page. In addition, the surrender quote interface is called in the asynchronous manner, and the interface can obtain a specific surrender amount and related fee information of the savings-type insurance product from the insurance company.

After the surrender quote interface returns the surrender quote result, a surrender confirmation page can be generated based on the surrender quote result. The surrender confirmation page can include detailed surrender information, to help the user understand a specific case of surrender more comprehensively. The user can perform a further operation on the surrender interaction page. After receiving the surrender confirmation instruction of the user, the generated surrender confirmation page can be returned to the user terminal. The user can view surrender-related content on the surrender confirmation page, and confirm a final surrender operation.

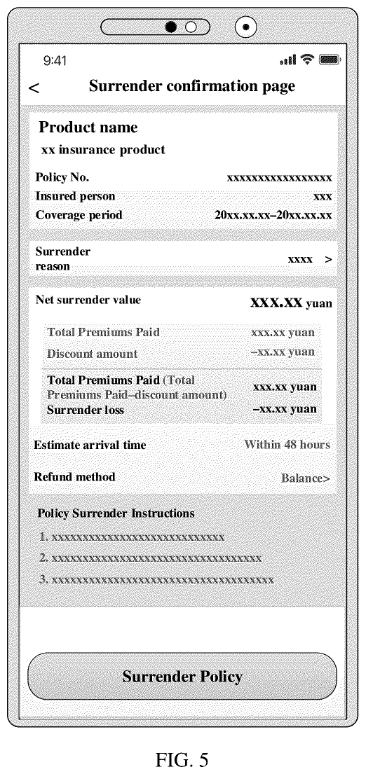

FIG. 5 is a schematic diagram of a surrender confirmation page according to one or more embodiments. For example, FIG. 5 shows the surrender confirmation page generated based on the surrender quote result.

In this embodiment, calling the surrender quote interface of the savings-type insurance product in the asynchronous manner for surrender quote processing can be performed after the surrender request submitted by the user terminal for the savings-type insurance product is received, or can be performed after the prediction parameter for surrender quote prediction is determined based on the product type of the savings-type insurance product, or can be performed when the surrender quote prediction is performed based on the prediction model. This is not limited in this embodiment.

After a surrender instruction submitted by the user terminal to confirm surrender by the user on the surrender confirmation page is received, surrender processing can be performed on the savings-type insurance product. Corresponding surrender funds are transferred to the user account based on a surrender arrival amount displayed on the surrender confirmation page. In a process of returning the surrender funds to the user, a corresponding surrender amount can be transferred out of an insurance account, and the corresponding surrender amount is transferred to the user account. A request can be submitted to an insurance institution, so that the insurance institution directly transfers the corresponding surrender amount to the user account.

In an embodiment, if the user performs a large quantity of times of interaction on the surrender interaction page or stays on the surrender interaction page a long time, the surrender confirmation page can be directly returned to the user after the surrender quote question triggered by the user is received, or after it is detected that the user submits a question including a quote keyword, or after the user triggers the surrender control.

In another implementation, in response to the surrender request, after the surrender quote interface of the savings-type insurance product is called in the asynchronous manner for surrender quote processing, and before the surrender confirmation page is generated based on the surrender quote result returned through an interface call, and the surrender confirmation page is returned to the user terminal after receiving the surrender confirmation instruction, the method further includes:
If the surrender quote question in the interaction question is triggered, or after it is detected that the question information submitted by the user terminal includes the quote keyword, or after the surrender instruction generated by triggering the surrender control is received, the following operations are performed: detecting whether an interface call result of the surrender quote interface is returned; and if yes, generating a surrender confirmation page based on a surrender quote result returned through an interface call, and returning the surrender confirmation page to the user terminal after receiving a surrender confirmation instruction; or if not, generating a processing page that carries the surrender loss range, and returning the processing page to the user terminal.

For example, when the user performs an operation on the surrender interaction page, the surrender quote interface can be called in the asynchronous manner to request the insurance company to return a surrender amount and a surrender loss of the savings-type insurance product of the user. If the interface call needs to take 30 seconds, an operation time of the user on the interaction page exceeds 30 seconds, and the user does not select or ask, on the surrender interaction page, a question involving the surrender amount or loss estimation, whether the interface call result of the surrender quote interface is returned is first detected. If it is detected that the result is returned, when it is detected that the surrender quote question in the interaction question is triggered, or after it is detected that the question information submitted by the user terminal includes the quote keyword, or after the surrender instruction generated by the surrender control through triggering is received, the surrender confirmation page can be directly generated based on the surrender quote result returned through the interface call, and the surrender confirmation page is returned to the user after the surrender confirmation instruction is received. If it is detected that the result is not returned, that is, the surrender confirmation page cannot be generated based on the surrender quote result returned through the interface call, the processing page that carries the surrender loss range is still generated and returned to the user terminal. In this case, the surrender loss range can be calculated based on the value calculation rule of the savings-type insurance product, or obtained through prediction based on the prediction parameter and the prediction model.

According to the online processing method provided in this embodiment, the user terminal generates and submits the surrender request for the savings-type insurance product. Based on the surrender request submitted by the user terminal, the surrender interaction page is generated and returned to the user terminal. In addition, the surrender confirmation page is loaded in the asynchronous manner, and the user terminal receives and displays the surrender interaction page, so that the user can ask and understand surrender-related information on the surrender interaction page. After the user triggers the surrender quote question on the surrender interaction page or asks the question that includes the quote keyword, if the processing institution stores the value calculation rule of the savings-type insurance product, surrender loss calculation is performed based on the insured-user data and the policy data, to obtain the surrender loss range. If the processing institution does not store the value calculation rule of the savings-type insurance product, the prediction parameter for surrender quote prediction can be determined in the insured-user data and the policy data based on the product type of the savings-type insurance product, the prediction parameter is input into the prediction model corresponding to the product type for surrender quote prediction, the predicted surrender loss range is obtained, and the obtained surrender loss range is returned to the user terminal, so that the user obtains surrender loss prediction. The user can determine, based on the surrender loss range, whether to further perform surrender processing. If yes, the surrender confirmation page can be returned to the user, and surrender processing is performed based on the surrender instruction that is submitted by the user terminal and that is submitted by the user on the surrender confirmation page. Based on this, in the asynchronous manner, the user learns of the surrender loss in advance, and a problem of a long page loading time of surrender quote is avoided.

The above implementation process of the online processing method can be performed by the server. An implementation process of another online processing method provided below can be performed by the user terminal. The two implementation processes can cooperate with each other in an execution process. Therefore, for the above implementation process, reference can be made to corresponding content of the following another online processing method embodiment. Correspondingly, for the following another online processing method embodiment, reference can also be made to corresponding content of the above method embodiment.

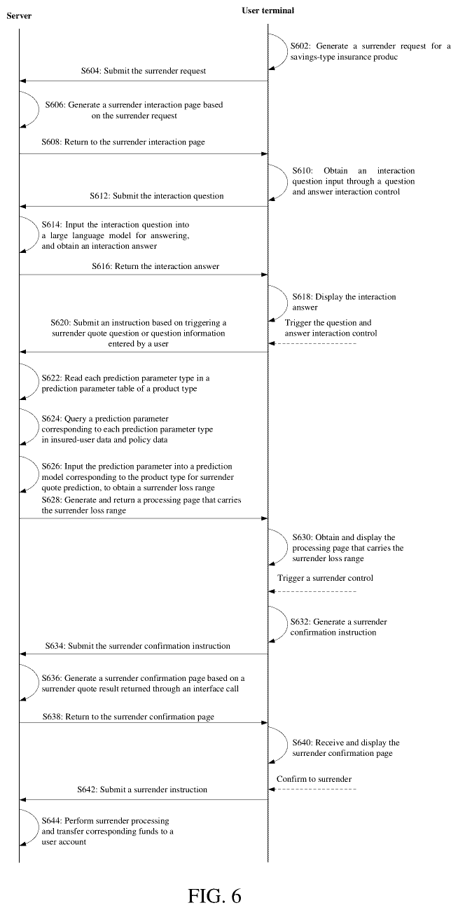

FIG. 6 is a flowchart of an online processing method applied to a surrender scenario according to one or more embodiments. As shown in FIG. 6, the online processing method applied to the surrender scenario can include the following steps.

Step S606: Generate a surrender interaction page based on a surrender request for a savings-type insurance product.

Step S608: Return the surrender interaction page to a user terminal.

Step S614: Receive an interaction question submitted by the user terminal, and input the interaction question into a large language model for answering, to obtain an interaction answer.

Step S616: Return the interaction answer to the user terminal.

Step S622: If it is detected that a surrender quote question is triggered or submitted question information includes a quote keyword, read each prediction parameter type in a prediction parameter table of a product type of the savings-type insurance product.

Step S624: Query a prediction parameter corresponding to each prediction parameter type in insurance user data and policy data.

Step S626: Input the prediction parameter into a prediction model corresponding to the product type of the savings-type insurance product for surrender quote prediction, to obtain a surrender loss range of the savings-type insurance product.

Step S628: Generate and return a processing page that carries the surrender loss range.

Step S636: Generate a surrender confirmation page, based on a surrender quote result returned through an interface call.

It should be noted that, a surrender quote processing process in step S622 to step S626 and step S636 of generating the surrender confirmation page based on the surrender quote result returned through the interface call are performed in the asynchronous manner.

Step S638: Return the surrender confirmation page to the user terminal.

Step S644: Perform surrender processing based on a surrender instruction submitted by the user terminal, and transfer corresponding surrender funds to a user account.

Step S606 to step S608, step S614 to step S616, step S622 to step S628, step S636 to step S638, and step S644 are performed by the server in this embodiment. It should be noted that those steps performed by the server and step S602 to step S604, step S610 to step S612, step S618 to step S620, step S630 to step S634, and step S640 to step S642 that are performed by the user terminal in the following embodiment may cooperate with each other in an execution process. For this embodiment, reference can be made to corresponding content of step S602 to step S604, step S610 to step S612, step S618 to step S620, step S630 to step S634, and step S640 to step S642 that are provided in the following method embodiment. For the following method embodiment, reference can be made to corresponding content of step S606 to step S608, step S614 to step S616, step S622 to step S628, step S636 to step S638, and step S644 provided in this embodiment.

It should be noted that any one or a combination of any one or more of step S606 to step S608, step S614 to step S616, step S622 to step S628, step S636 to step S638, and step S644 can be combined into a new implementation with any one or more of steps S202 to S206 based on an implementation and deployment requirement. In addition, any one or more technical features can be selected from step S606 to step S608, step S614 to step S616, step S622 to step S628, step S636 to step S638, and step S644 based on an implementation and deployment requirement, and are combined into a new implementation with any one or more technical features provided in step S202 to step S206. Alternatively, any one or more of the following technical features of step S606 to step S608, step S614 to step S616, step S622 to step S628, step S636 to step S638, and step S644 can be replaced with any one or more of the foregoing technical features provided in step S202 to step S206 based on an implementation and deployment requirement to form a new implementation. Details are not repeated herein.

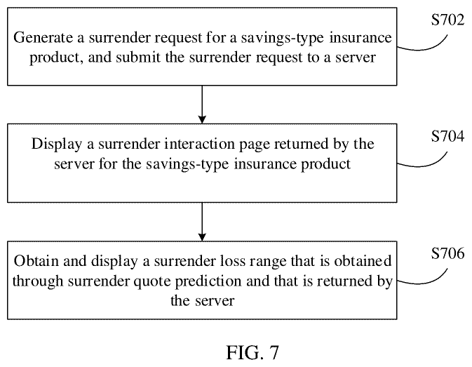

FIG. 7 is a flowchart of an online processing method according to one or more embodiments. As shown in FIG. 7, the online processing method can be applied to a user terminal, and can include steps S702 to S706.

Step S702: Generate a surrender request for an insurance product, such as a savings-type insurance product, and submit the surrender request to a server.

For example, the savings-type insurance product combines a saving and an insurance function and provides certain insurance while providing fund accumulation for a user. The user can regularly pay a premium, a part of the paid premium can be deposited into a savings account of the user, and the user can choose to withdraw such funds after a specified period. In addition, if an agreed risk event occurs within a coverage period, the user can obtain corresponding funds paid by an insurance company based on an agreement.

Savings-type insurance products can have a plurality of product types that can include a savings-type insurance product of a savings type, a savings-type insurance product of a dividends type, a savings-type insurance product of a floating income type, etc.

In an embodiment, after the user joins the savings-type insurance product, the user can choose to exit the savings-type insurance product. That the user exits the savings-type insurance product is referred to as surrender. For the savings-type insurance product, after the user requests surrender, a certain amount of funds need to be returned to the user. Specifically, a process of calculating funds to be returned to the user is referred to as surrender quote.

After the user chooses to exit the savings-type insurance product, the user can submit a surrender request. The surrender request is a request that the user applies to the insurance company to exit the savings-type insurance product. The surrender interaction page is a user page that interacts with the user in a surrender process.

In an implementation, in a surrender process, the surrender request for the savings-type insurance product can be generated and submitted to the server. Herein, after the surrender request is submitted, the server can generate the surrender interaction page in response to the submitted surrender request, and return the generated surrender interaction page. Correspondingly, the surrender interaction page returned by the server is received.

Step S704: Display a surrender interaction page returned by the server for the savings-type insurance product.

In an implementation, the server generates the surrender interaction page based on the surrender request, and then returns the generated surrender interaction page. Correspondingly, the surrender interaction page returned by the server is obtained, and the surrender interaction page is displayed.

For example, in a process of generating the surrender interaction page, to improve a response speed and efficiency of an interaction process, a processing module that is specifically used to perform interaction in the surrender process of the insurance product can be further configured. For example, interaction processing can be performed by using an interactive robot. Herein, the surrender interaction page can also be generated by the interactive robot.

In an embodiment, the method is applied to an interactive robot that performs surrender interaction processing on the insurance product. The surrender interaction page includes a surrender interaction page generated by the interactive robot for the savings-type insurance product.

The surrender interaction page can include any one or more elements in an interaction question, a question and answer interaction control, and/or a surrender control. For example, the surrender interaction page can include the interaction question, and the interaction question can be preset, to guide the user to understand a surrender procedure and related information. The surrender interaction page can further include the question and answer interaction control, so that the user can enter a surrender-related question and obtain a corresponding feedback and answer. The surrender interaction page can further include a surrender control, so that the user can perform a specific surrender operation. Optionally, the surrender interaction page includes the interaction question, the question and answer interaction control, and/or the surrender control.

In a specific execution process, after generating and returning the surrender interaction page, the server can display the received surrender interaction page, so that the user can learn about a surrender-related procedure and information on the surrender interaction page. To improve efficiency of surrender processing and provide the user with an accurate and detailed answer to the surrender-related question, in an optional implementation provided in this embodiment, the method further includes: obtaining an interaction question input through the question and answer interaction control, and submitting the interaction question to the server; and displaying, in the question and answer interaction control, an interaction answer returned by the server.

For example, after the surrender interaction page is generated based on the surrender request and returned to the user terminal, the user can enter, on the surrender interaction page by using the question and answer interaction control, an interaction question that the user wants to understand. The interaction question can include aspects such as a specific process of surrender, a required material, and surrender amount estimation. The interaction question submitted by the user is sent to the server, and the server receives ad parse the interaction process, and then inputs the interaction question into a large language model. The large language model can analyze the interaction question of the user, and generate a corresponding interaction answer. The server returns the generated interaction answer. After the interaction answer returned by the server is received, the interaction answer is displayed in the question and answer interaction control on the surrender interaction page, so that the user can further understand related information of surrender based on the interaction answer.

In an embodiment, the interaction answer is obtained by inputting the interaction question into the large language model for answering.

In a specific execution process, to improve accuracy of the surrender result and enable the user to obtain accurate surrender loss information, the server generates and returns the surrender interaction page, and can first detect whether a processing institution has a value calculation rule that can be directly used to calculate the surrender loss. In an implementation, after the surrender interaction page is generated based on the surrender request submitted by the user terminal for the savings-type insurance product, and returned to the user terminal, and before the prediction parameter for surrender quote prediction is determined in the insured-user data and the policy data based on the product type of the savings-type insurance product, the method further includes: detecting whether a processing institution stores a value calculation rule for savings-type insurance product; and if no, performing the step of determining a prediction parameter for surrender quote prediction in insured-user data and policy data based on a product type of the savings-type insurance product.

In this case, the value calculation rule is a predefined rule used to calculate a policy cash value and/or a surrender loss of the savings-type insurance product. The value calculation rule can be used to calculate a precise surrender loss range, that is, a surrender loss actually returned to the user.

For example, after the surrender interaction page is generated, whether the processing institution stores the value calculation rule of the savings-type insurance product can be first detected. If a detection result is that the processing institution does not store the value calculation rule of the savings-type insurance product, it indicates that the prestored calculation rule cannot be directly used to precisely calculate the surrender loss of the savings-type insurance product, and the prediction parameter for the surrender quote prediction needs to be determined based on the product type of the savings-type insurance product, to further obtain the surrender loss range.

In addition, if the detection result is that the processing institution stores the value calculation rule of the savings-type insurance product, it indicates that the prestored calculation rule can be used to precisely calculate the surrender loss of the savings-type insurance product. In this case, the following optional implementation can be used to obtain the specific surrender loss range.

In an implementation, if a result obtained by detecting whether the processing institution stores the value calculation rule for the savings-type insurance product is yes, the following operations are performed: querying a surrender calculation parameter in the value calculation rule based on the insured-user data and the policy data; and inputting the surrender calculation parameter into a surrender loss algorithm for surrender loss calculation, to obtain the surrender loss range.

For example, if the detection result is that the processing institution stores the value calculation rule of the savings-type insurance product, the insured-user data and the policy data can be first obtained from the surrender request of the user, and then the surrender calculation parameter is quired in the value calculation rule based on the insured-user data and the policy data. The surrender calculation parameter can be shown in Table 3. Then, a specific value and a calculation method that are related to the surrender calculation parameter can be extracted from the prestored value calculation rule, and the surrender calculation parameter is input into the surrender loss algorithm for surrender loss calculation, to obtain the surrender loss range.

TABLE 3

| Parameter | | |
|---|---|---|
| type | Parameter value/meaning | Specific value |
| Policy year | Current policy year, integer | x |
| Date of birth | Date of birth of an insured | xx (month) xx (day), xxxx |
| | person | (year) |
| User type | Insured-user type | 1: Male 2: Female |
| Payment | Payment frequency | 01: Lump-sum payment 02: |
| method | | Monthly payment |
| | | 03: Annual payment 04: |
| | | Half-monthly payment |
| Payment | By year: nY; By date of | xY: Pay for x years |
| period | birth nA | XA: Pay until age X |
| Payout | By year: nY; By date of | xY: Payout for x years; |
| period | birth nA | xA: Payout until age X |
| Start payout | By year: nY; By date of | xY: Payout after x years; |
| period | birth nA | xA: Payout after age x; |
| Year-end | Calculate a current year-end | If the current year-end price |
| cash value | price based on a ratio | of each 1000 yuan premium is |
| | between a premium to the | 1500 yuan, and 10000 yuan is |
| | current year-end price | configured, the current year- |
| | | end price is 15000 yuan |

Further, to enable the user to understand a possible fund loss range during surrender, and provide reference information for the user to evaluate surrender impact, when a possible loss of the user during surrender is calculated based on the policy data and the surrender calculation parameter, a clear surrender loss range can be provided for the user. In an optional implementation provided in this embodiment, the surrender loss calculation includes: calculating a first loss amount between an accumulated insurance amount and a policy value of a coverage period including a current time, and calculating a second loss amount between the accumulated insurance amount and a policy value of a previous coverage period; and calculating ratios of the first loss amount and the second loss amount to the accumulated insurance amount as a loss upper limit and a loss lower limit of the surrender loss range.

In this process, a difference between the accumulated insurance amount and the policy value of the coverage period including the current time is calculated as the first loss amount, and a difference between the accumulated insurance amount and the policy value of the previous coverage period is calculated as the second loss amount; and then a ratio between the first loss amount and the accumulated insurance amount is used as the loss upper limit of the surrender loss range, and a ratio between the second loss amount and the accumulated insurance amount is used as the loss lower limit of the surrender loss range, to determine a specific surrender loss range.

For example, if the user insures on x (month) x (day), 2021 and surrenders on x (month) x (day), 2024, based on policy data such as a date of birth of an insured person, a user type, a payment method, a payment period, a payout period of the product, and a start payment period in a policy of the user, a current policy year is 4, and a cash value ratio at the end of the third policy year and a cash value ratio at the end of the fourth policy year can be obtained. Based on Surrender loss ratio=(Accumulated investment−Policy cash value)/Accumulated investment, surrender loss ratios x1 and x2 are calculated. The surrender loss ratio x1 can be used as the loss lower limit of the surrender loss range, and the surrender loss ratio x2 is used as the loss upper limit of the surrender loss range. In this case, a surrender loss of the user falls within a range is [x1, x2].

In addition, after the server generates and returns the surrender interaction page to the user terminal, before the user enters the surrender interaction page or after the user enters the surrender interaction page, a mandatory option page or a mandatory option pop-up window can be further set, and the mandatory option page or the mandatory option pop-up window is displayed. The mandatory option page or the mandatory option pop-up window can configure a mandatory option of the surrender-related question, for example, a surrender reason and a user requirement, or may not configure a mandatory option, but set the surrender-related question. The user can fill in or select based on an individual condition, to better understand the user requirement, to provide targeted content of the surrender interaction page based on a user selection.

Step S706: Obtain and display a surrender loss range that is obtained through surrender quote prediction and that is returned by the server.

In an embodiment, after the user joins the savings-type insurance product, the user can choose to exit the savings-type insurance product. After the user requests surrender, a certain amount of funds need to be returned to the user. A process of calculating funds to be returned to the user, a possible loss of the user, etc. is referred to as surrender quote.

As described above, the savings-type insurance product can have three product types. In a surrender quote prediction process, prediction parameters required for savings-type insurance products of different product types may be different. Herein, a corresponding prediction parameter can be determined based on the product type of the savings-type insurance product, the insured-user data, and the policy data, to perform further surrender quote prediction.

In the specific execution process, to improve accuracy of a surrender quote prediction result, and improve flexibility and adaptability of the surrender quote prediction process, proper prediction parameters can be selected based on different product types of the savings-type insurance product. In an optional implementation provided in this embodiment, determining the prediction parameter for surrender quote prediction in the insured-user data and the policy data based on the product type of the savings insurance product includes: reading each prediction parameter type in a prediction parameter table of the product type; and querying a prediction parameter corresponding to each prediction parameter type in the insured-user data and the policy data.

The prediction parameter type is a predefined parameter type based on a type, content, etc. of the savings-type insurance product, and can include a policy year, a birth date of an insured person, a user type, a payment frequency, a payment period, a payment period, a payout period, a start payout period, etc.

For example, in a process of determining the prediction parameter for the surrender quote prediction, each prediction parameter type can be read from a prediction parameter table corresponding to the product type of the savings-type insurance product; and then a prediction parameter corresponding to each prediction parameter type is queried in the insured-user data and the policy data, and surrender quote prediction is performed based on the found prediction parameter.

For example, Table 4 shows a prediction parameter table of a savings-type insurance product of a savings type. A specific prediction parameter corresponding to each prediction parameter type such as a policy year, a user type, a payment frequency, a payment period, a payout period, a start payout period, and a surrender loss range can be found in the prediction parameter table, and the found prediction parameter is input into a corresponding prediction model for surrender quote prediction.

TABLE 4

| | | | | | Start | |
|---|---|---|---|---|---|---|
| Policy | User | Payment | Payment | Payout | Payout | Surrender loss |
| year | type | frequency | period | period | period | range |
| 7 | 1 | 01 | NA | 5 Y | 20 Y | No loss |
| 6 | 1 | 01 | NA | 5 Y | 20 Y | 0-5% |
| 5 | 1 | 01 | NA | 5 Y | 20 Y | |
| 4 | 1 | 01 | NA | 5 Y | 20 Y | 5%-10% |
| 4 | 1 | 01 | NA | 5 Y | 20 Y | |
| 3 | 1 | 01 | NA | 5 Y | 20 Y | 10%-20% |
| 2 | 1 | 01 | NA | 5 Y | 20 Y | 30%-50% |
| 2 | 1 | 01 | NA | 5 Y | 20 Y | |
| 1 | 1 | 01 | NA | 5 Y | 20 Y | More than 50% |
| 1 | 1 | 01 | NA | 5 Y | 20 Y | |

In an embodiment, the surrender quote prediction is performed by inputting a prediction parameter determined in user data and policy data of an insured user into a prediction model corresponding to a product type of the savings-type insurance product.

The prediction model is configured to predict, based on the insured-user data and the policy data of the user and based on a specific product type and a value calculation rule of the savings insurance product, a possibly obtained amount and a loss of the user during surrender. Corresponding models can be set for product types of different savings-type insurance products. For example, different models can be trained in a case of different prediction parameters, and the same model can be used in a case of similar prediction parameters. The prediction parameter determined from the insured-user data and the policy data can be input into the prediction model based on the product type of the savings-type insurance product. The surrender loss range is output. The surrender loss range includes a loss upper limit value and a loss lower limit value.

In an implementation, considering that different savings-type insurance products may have different calculation rules, to improve prediction accuracy, the server can first determine a corresponding prediction model based on the product type of the savings-type insurance product, so that the prediction model matches a specific savings-type insurance product, and then the prediction parameter found from the insured-user data and the policy data is input into the corresponding prediction model for surrender quote prediction, to obtain an estimated surrender loss range. The server returns the estimated surrender loss range, and correspondingly, obtains and displays the surrender loss range that is obtained through surrender quote prediction and that is returned by the server, so that the user learns of the surrender quote that may be faced.

In a specific execution process, after the user triggers the surrender quote question on the surrender interaction page or submits the question that includes the quote keyword on the surrender interaction page, the user can perform surrender quote prediction, and return the predicted surrender loss range to the user terminal, to respond to the quote requirement of the user in a timely manner and provide the user with immediate surrender loss estimation. In an implementation, the method further includes: receiving and displaying a processing page that carries the surrender loss range and that is returned by the server; and generating a surrender confirmation instruction after the surrender control configured on the processing page is triggered, and submitting the surrender confirmation instruction to the server.

For example, when the user clicks or selects a specific question related to the surrender quote on the surrender interaction page, a trigger action of the user can be identified, a corresponding instruction is generated based on the triggering action of the user, and the instruction is submitted to the server. After receiving the submitted triggering instruction, the server can start a surrender quote prediction procedure. Alternatively, when it is detected that the user submits, in the question and answer interaction control on the surrender interaction page, the question information that includes a quote or a keyword with a similar meaning of the quote, etc., the surrender quote prediction can also be triggered. Correspondingly, after the surrender quote prediction is performed, the server can return the obtained surrender loss range. After the surrender loss range returned by the server is received, the surrender loss range can be displayed in the question and answer interaction control on the surrender interaction page. A pop-up window or a page that includes a surrender loss range and that is returned by the server is obtained and displayed.

For example, as shown in FIG. 3, the surrender interaction page can include a question and answer interaction control 301, a surrender control 302, interaction questions 303-1, 303-2, and 303-3, etc. The user can directly select, based on the displayed interaction questions, a question that the user wants to understand, or can click a question button in the question and answer interaction control, to input a question.

In an embodiment, in a process in which the user interacts on the surrender interaction page, if a question selected or entered by the user does not involve a surrender amount or loss estimation, or if the user directly triggers the surrender control to select surrender after entering the surrender interaction page, to enable the user to learn of a fund loss that may be faced in a case of surrender, surrender quote prediction can be performed, and a surrender range is returned to the user after the user triggers the surrender control.

In an implementation, determining of the prediction parameter and the surrender quote prediction are performed after a surrender instruction generated by triggering the surrender control is received.

For example, when the user does not select or ask, on the surrender interaction page, a question related to the surrender amount or loss estimation, but selects or asks a general question related to a surrender procedure and then triggers the surrender control; or the user does not perform interaction question-answering on the surrender interaction page, but directly trigger the surrender control, the surrender quote prediction can be performed after the user triggers the surrender control, and the processing page that carries the surrender loss range is returned. Correspondingly, after the processing page returned by the server is received, before the final surrender confirmation page is displayed, the processing page that carries the surrender loss range can be displayed to the user, so that the user learns of the surrender loss range, and determines whether to continue to surrender.

For example, after the user clicks the surrender control 302 shown in FIG. 3, surrender quote prediction can be performed based on the received surrender instruction generated by triggering the surrender control. Correspondingly, a pop-up window 401 that carries the surrender loss range shown in FIG. 4 or a processing page that carries the surrender loss range can be generated and returned to the user terminal, to display the predicted surrender loss range to the user.

In the specific execution process, to prevent the user from waiting too long time when accessing the surrender confirmation page, after the surrender request submitted by the user terminal for the savings-type insurance product is received, interaction question-answering is performed with a customer, and a surrender loss is estimated. In addition, the surrender confirmation page can be loaded asynchronously, so that the user learns of the surrender loss in advance, and a problem of a long page loading time of the surrender confirmation page is avoided. In an implementation, the method further includes: receiving and displaying a surrender confirmation page that is generated based on a surrender quote result and that is returned by the server.

In an embodiment, the surrender quote result is obtained by calling, in an asynchronous manner, a surrender quote interface of the savings-type insurance product for surrender quote processing.

For example, in response to the submitted surrender request, the server can call the surrender quote interface of the savings-type insurance product in the asynchronous manner for surrender quote processing. That is, a response result of the surrender quote interface is not waited, but a surrender interaction page is returned to the user terminal, so that the user can continue to browse or perform another operation while waiting for the surrender confirmation page. In addition, the surrender quote interface is called in the asynchronous manner, and the interface can obtain a specific surrender amount and related fee information of the savings-type insurance product from the insurance company.

After the surrender quote interface returns the surrender quote result, a surrender confirmation page can be generated based on the surrender quote result. The surrender confirmation page can include detailed surrender information, to help the user understand a specific case of surrender more comprehensively. The user can perform a further operation on the surrender interaction page. After receiving the surrender confirmation instruction of the Server user, the server can return the generated surrender confirmation page, and correspondingly, the surrender confirmation page returned by the server can be received and displayed, so that the user can view surrender-related content on the surrender confirmation page, and confirm a final surrender operation.

For example, FIG. 5 shows the surrender confirmation page generated based on the surrender quote result.

In this embodiment, calling the surrender quote interface of the savings-type insurance product in the asynchronous manner for surrender quote processing can be performed after the surrender request submitted by the user terminal for the savings-type insurance product is received, or can be performed after the prediction parameter for surrender quote prediction is determined based on the product type of the savings-type insurance product, or can be performed when the surrender quote prediction is performed based on the prediction model. This is not limited in this embodiment.

After a surrender instruction submitted by the user terminal to confirm surrender by the user on the surrender confirmation page is received, surrender processing can be performed on the savings-type insurance product. Corresponding surrender funds are transferred to the user account based on a surrender arrival amount displayed on the surrender confirmation page. In a process of returning the surrender funds to the user, a corresponding surrender amount can be transferred out of an insurance account, and the corresponding surrender amount is transferred to the user account. A request can be submitted to an insurance institution, so that the insurance institution directly transfers the corresponding surrender amount to the user account.

In an embodiment, if the user performs a large quantity of times of interaction on the surrender interaction page or stays on the surrender interaction page a long time, the surrender confirmation page can be directly returned to the user after the surrender quote question triggered by the user is received, or after it is detected that the user submits a question including a quote keyword, or after the user triggers the surrender control.

In an implementation, in response to the surrender request, after the surrender quote interface of the savings-type insurance product is called in the asynchronous manner for surrender quote processing, and before the surrender confirmation page is generated based on the surrender quote result returned through an interface call, and the surrender confirmation page is returned to the user terminal after receiving the surrender confirmation instruction, the method further includes:
If the surrender quote question in the interaction question is triggered, or after it is detected that the question information submitted by the user terminal includes the quote keyword, or after the surrender instruction generated by triggering the surrender control is received, the following operations are performed: detecting whether an interface call result of the surrender quote interface is returned; and if yes, generating a surrender confirmation page based on a surrender quote result returned through an interface call, and returning the surrender confirmation page to the user terminal after receiving a surrender confirmation instruction; or if not, generating a processing page that carries the surrender loss range, and returning the processing page to the user terminal.

For example, when the user performs an operation on the surrender interaction page, the surrender quote interface can be called in the asynchronous manner to request the insurance company to return a surrender amount and a surrender loss of the savings-type insurance product of the user. If the interface call needs to take 30 seconds, an operation time of the user on the interaction page exceeds 30 seconds, and the user does not select or ask, on the surrender interaction page, a question involving the surrender amount or loss estimation, whether the interface call result of the surrender quote interface is returned is first detected. If it is detected that the result is returned, when it is detected that the surrender quote question in the interaction question is triggered, or after it is detected that the question information submitted by the user terminal includes the quote keyword, or after the surrender instruction generated by the surrender control through triggering is received, the surrender confirmation page can be directly generated based on the surrender quote result returned through the interface call, and the surrender confirmation page is returned to the user after the surrender confirmation instruction is received. If it is detected that the result is not returned, that is, the surrender confirmation page cannot be generated based on the surrender quote result returned through the interface call, the processing page that carries the surrender loss range is still generated and returned to the user terminal. In this case, the surrender loss range can be calculated based on the value calculation rule of the savings-type insurance product, or obtained through prediction based on the prediction parameter and the prediction model.

According to the online processing method provided in this embodiment, the surrender request for the savings-type insurance product is first generated and submitted to the server. The server generates the surrender interaction page in the asynchronous manner based on the surrender request, and returns the surrender interaction page to the user terminal. In addition, the surrender confirmation page is loaded, and the surrender interaction page returned by the server is received and displayed, so that the user can ask and understand surrender-related information on the surrender interaction page. When the user triggers the surrender quote question in the surrender interaction question on the surrender interaction page or asks the question that includes the quote keyword, a corresponding request is sent to the server. The server detects whether the processing institution stores the value calculation rule of the savings-type insurance product. If the processing institution stores the value calculation rule of the savings-type insurance product, surrender loss calculation is performed based on the insured-user data the policy data, to obtain the surrender loss range. If the processing institution does not store the value calculation rule of the savings-type insurance product, the prediction parameter for surrender quote prediction can be determined in the insured-user data and the policy data based on the product type of the savings-type insurance product, the prediction parameter is input into the prediction model corresponding to the product type for surrender quote prediction, the predicted surrender loss range is obtained, and the surrender loss range returned by the server is received and displayed, so that the user obtains surrender loss prediction. The user can determine, based on the surrender loss range, whether to further perform surrender processing. If yes, the surrender confirmation page can be returned to the user, and the surrender instruction submitted by the user on the surrender insurance page is sent to the server for surrender processing. Based on this, in the asynchronous manner, the user learns of the surrender loss in advance, and a problem of a long page loading time of surrender quote is avoided.

The following further describes the online processing method provided in this embodiment with reference to FIG. 6 by using an example in which the online processing method is applied to a surrender scenario. As shown in FIG. 6, the online processing method can include the following steps.

Step S602: Generate a surrender request for a savings-type insurance product.

Step S604: Submit the surrender request for the savings-type insurance product to a server.

Step S610: Receive a surrender interaction page returned by the server, and obtain an interaction question entered through a question and answer interaction control on the surrender interaction page.

Step S612: Submit the interaction question to the server.

Step S618: Receive an interaction answer returned by the server, and display the interaction answer.

Step S620: When triggering a surrender quote question or question information entered by the user is received, submit, to the server, an instruction generated based on triggering the surrender quote question or the question information entered by the user.

Step S630: Obtain and display a processing page that carries a surrender loss range and that is returned by the server.

Step S632: Generate a surrender confirmation instruction after it is detected that the surrender control configured on the surrender page is triggered.

Step S634: Submit the surrender confirmation instruction to the server.

Step S640: Receive and display a surrender confirmation page returned by the server.

Step S642: Submit a surrender instruction to the server after triggering surrender confirmation on the surrender confirmation page by the user is received.

It should be noted that any one or a combination of any one or more of step S602 to step S604, step S610 to step S612, step S618 to step S620, step S630 to step S634, and step S640 to step S642 can be combined into a new implementation with any one or more of steps S702 to S706 based on an implementation and deployment requirement. In addition, any one or more technical features can be selected from step S602 to step S604, step S610 to step S612, step S618 to step S620, step S630 to step S634, and S640 to step S642 based on an implementation and deployment requirement, and are combined into a new implementation with any one or more technical features provided in step S702 to step S706. Alternatively, any one or more of the following technical features of step S602 to step S604, step S610 to step S612, step S618 to step S620, step S630 to step S634, and S640 to step S642 can be replaced with any one or more of the foregoing technical features provided in step S702 to step S706 based on an implementation and deployment requirement to form a new implementation. Details are not repeated herein.

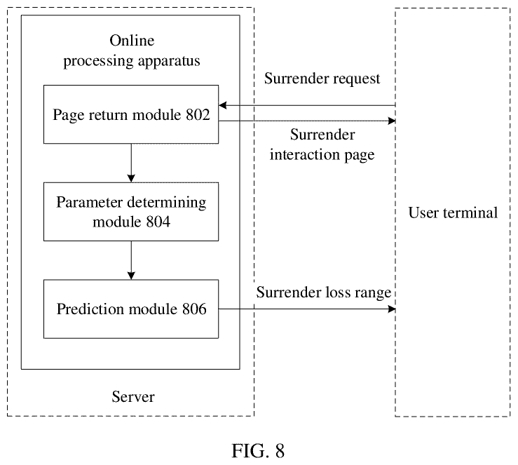

FIG. 8 is a schematic diagram of an online processing apparatus according to one or more embodiments. The apparatus includes: a page return module 802, configured to: generate a surrender interaction page based on a surrender request submitted by a user terminal for a savings-type insurance product, and return the surrender interaction page to the user terminal; a parameter determining module 804, configured to determine a prediction parameter for surrender quote prediction in insured-user data and policy data based on a product type of the savings-type insurance product; and a prediction module 806, configured to input the prediction parameter into a prediction model corresponding to the product type for surrender quote prediction, to obtain a surrender loss range and return the surrender loss range to the user terminal.

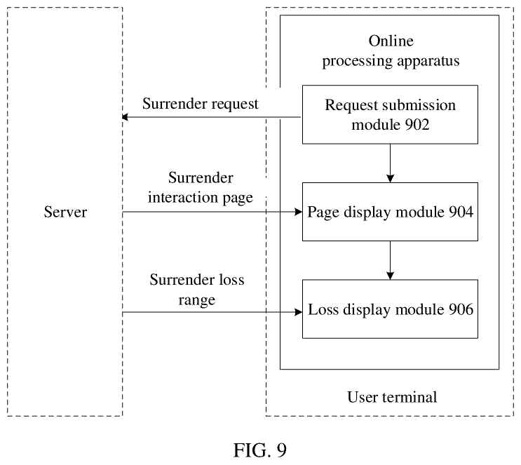

FIG. 9 is a schematic diagram of an online processing apparatus according to one or more embodiments. The apparatus includes: a request submission module 902, configured to: generate a surrender request for a savings-type insurance product, and submit the surrender request to a server; a page display module 904, configured to display a surrender interaction page returned by the server for the savings-type insurance product; and a loss display module 906, configured to obtain and display a surrender loss range that is obtained through surrender quote prediction and that is returned by the server, where the surrender quote prediction is performed by inputting a prediction parameter determined in user data and policy data of an insured user into a prediction model corresponding to a product type of the savings-type insurance product.

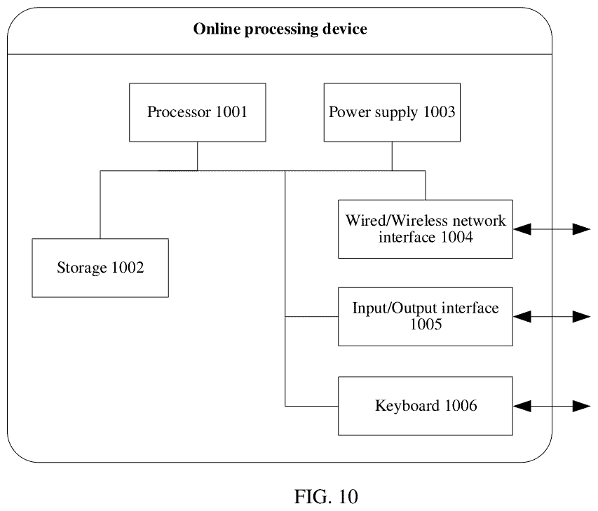

FIG. 10 is a schematic diagram of an online processing device according to one or more embodiments. The online processing device can vary based on configuration or performance, and can include one or more processors 1001 and a storage 1002. The storage 1002 can store one or more storage applications or data. The storage 1002 can be a temporary storage or a persistent storage. The application stored in the storage 1002 can include one or more modules (not shown in the figure), and each module can include a series of computer-executable instructions in the online processing device. Further, the one or more processors 1001 can be configured to perform the method illustrated above in FIG. 2. The online processing device can further include one or more power supplies 1003, one or more wired or wireless network interfaces 1004, one or more input/output interfaces 1005, one or more keyboards 1006, etc.

In an embodiment, the one or more processors 1001 are configured to: generate a surrender interaction page based on a surrender request submitted by a user terminal for a savings-type insurance product, and return the surrender interaction page to the user terminal; determine a prediction parameter for surrender quote prediction in insured-user data and policy data based on a product type of the savings-type insurance product; and input the prediction parameter into a prediction model corresponding to the product type for surrender quote prediction, to obtain a surrender loss range and return the surrender loss range to the user terminal.

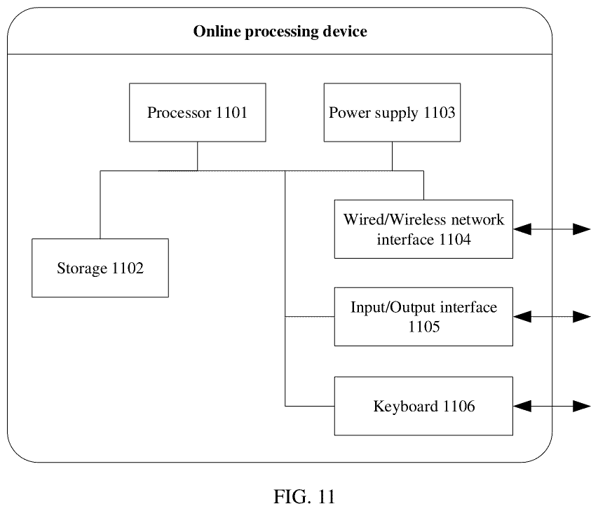

FIG. 11 is a schematic diagram of an online processing device according to one or more other embodiments. As shown in FIG. 11, the online processing device can vary based on configuration or performance, and can include one or more processors 1101 and a storage 1102. The storage 1102 can store one or more storage applications or data. The storage 1102 can be used for transient storage or persistent storage. The application stored in the storage 1102 can include one or more modules (not shown in the figure), and each module can include a series of computer-executable instructions in the online processing device. Further, the one or more processors 1101 can be configured to perform the method illustrated above in FIG. 7. The online processing device can further include one or more power supplies 1103, one or more wired or wireless network interfaces 1104, one or more input/output interfaces 1105, one or more keyboards 1006, etc.

In an embodiment, the one or more processors 1101 are configured to: generate a surrender request for a savings-type insurance product, and submitting the surrender request to a server; display a surrender interaction page returned by the server for the savings-type insurance product; and obtain and display a surrender loss range that is obtained through surrender quote prediction and that is returned by the server, where the surrender quote prediction is performed by inputting a prediction parameter determined in user data and policy data of an insured user into a prediction model corresponding to a product type of the savings-type insurance product.

Embodiments of this specification also provide a non-transitory computer-readable storage medium storing instructions that, when executed by a processor of a server, cause the server to perform: generating a surrender interaction page based on a surrender request submitted by a user terminal for a savings-type insurance product, and returning the surrender interaction page to the user terminal; determining a prediction parameter for surrender quote prediction in insured-user data and policy data based on a product type of the savings-type insurance product; and inputting the prediction parameter into a prediction model corresponding to the product type for surrender quote prediction, to obtain a surrender loss range and return the surrender loss range to the user terminal.

Embodiments of this specification also provide a non-transitory computer-readable storage medium storing instructions that, when executed by a processor of a user terminal, cause the user terminal to perform: generating a surrender request for a savings-type insurance product, and submitting the surrender request to a server; displaying a surrender interaction page returned by the server for the savings-type insurance product; and obtaining and displaying a surrender loss range that is obtained through surrender quote prediction and that is returned by the server, where the surrender quote prediction is performed by inputting a prediction parameter determined in user data and policy data of an insured user into a prediction model corresponding to a product type of the savings-type insurance product.

Example embodiments of this specification are described above. Other embodiments fall within the scope of the appended claims. In some cases, the actions or steps described in the claims can be performed in an order different from that in the embodiments and desired results can still be achieved. In addition, the process depicted in the accompanying drawings does not necessarily require the shown particular execution order to achieve the desired results. In some implementations, multitasking and parallel processing are feasible or may be advantageous.

In some embodiments, the online processing device described above can be obtained by programming the online processing method process into a hardware circuit. For example, a programmable logic device (PLD) (for example, a field programmable gate array (FPGA)) is such an integrated circuit, and a logical function of the programmable logic device is determined by a user through device programming. In some embodiments, instead of manually manufacturing an integrated circuit chip, such programming is mostly implemented by using “logic compiler” software. The logic compiler software is similar to a software compiler used to develop and write a program. Original code needs to be written in a particular programming language for compilation. The language is referred to as a hardware description language (HDL). There are many HDLs, such as the Advanced Boolean Expression Language (ABEL), the Altera Hardware Description Language (AHDL), Confluence, the Cornell University Programming Language (CUPL), HDCal, the Java Hardware Description Language (JHDL), Lava, Lola, MyHDL, PALASM, and the Ruby Hardware Description Language (RHDL). The very-high-speed integrated circuit hardware description language (VHDL) and Verilog are most commonly used. It should also be clear to a person skilled in the art that a hardware circuit that implements a logical method procedure can be readily obtained once the method procedure is logically programmed by using the several hardware description languages described above and is programmed into an integrated circuit.

In some embodiments, a controller can be used to implement the online processing device. For example, the controller can use a form such as a microprocessor, a processor, or a computer-readable medium, a logic gate, a switch, an application specific integrated circuit (ASIC), a programmable logic controller, or an embedded microcontroller storing computer-readable program code (such as software or firmware) that can be executed by the (micro) processor. A storage controller can also be implemented as a part of control logic of the storage. A person skilled in the art also knows that in addition to implementing the controller by using only the computer-readable program code, logic programming can be performed on method steps to enable the controller to implement the same function in a form of a logic gate, a switch, an application specific integrated circuit, a programmable logic controller, or an embedded microcontroller.

Systems, apparatuses, modules, or units that are set forth in the previous implementations can be embodied by a computer chip or an entity or by a product with a specific function. An example implementation device is a computer. For example, the computer can be, for example, a personal computer, a laptop computer, a cellular phone, a camera phone, a smartphone, a personal digital assistant, a media player, a navigation device, an email device, a game console, a tablet computer, or a wearable device, or a combination of any of these devices.

For ease of description, the above apparatus is described by dividing functions into various modules. In some embodiments, a function of each module can be implemented in one or more pieces of software and/or hardware.

This specification is described with reference to the flowcharts and/or block diagrams of the method and the device. It should be understood that computer program instructions can be used to implement each procedure and/or each block in the flowcharts and/or the block diagrams and a combination of a procedure and/or a block in the flowcharts and/or the block diagrams. These computer program instructions can be provided to a general-purpose computer, a special-purpose computer, an embedded processor, or a processor of another programmable network live streaming processing device to generate a machine, so that the instructions executed by the computer or the processor of the another programmable network live streaming processing device generate an apparatus for implementing a specific function in one or more procedures in the flowcharts and/or in one or more blocks in the block diagrams.

These computer program instructions may be stored in a computer-readable storage that can instruct the computer or any other programmable network live streaming processing device to work in a specific method, so that the instructions stored in the computer-readable storage generate an artifact that includes an instruction apparatus. The instruction apparatus implements a specific function in one or more processes in the flowcharts and/or in one or more blocks in the block diagrams.

Alternatively, these computer program instructions can be loaded onto a computer or another programmable network live streaming processing device, so that a series of operations and steps are performed on the computer or another programmable device, to generate computer-implemented processing. Therefore, the instructions executed on the computer or the another programmable device provide steps for implementing a specific function in one or more procedures in the flowcharts and/or in one or more blocks in the block diagrams.

Examples of the non-transitory computer-readable storage medium described above include but are not limited to a phase change random access memory (PRAM), a static random access memory (SRAM), a dynamic random access memory (DRAM), another type of random access memory (RAM), a read-only memory (ROM), an electrically erasable programmable read-only memory (EEPROM), a flash memory or another memory technology, a compact disc read-only memory (CD-ROM), a digital versatile disc (DVD) or another optical storage, a cassette magnetic tape, magnetic disk storage, another magnetic storage device, or any other non-transmission medium. The computer-readable storage medium can be configured to store information that can be accessed by a computing device. As described in this specification, the computer-readable medium does not include computer-readable transitory media such as a modulated data signal and a carrier.

It is noted that the terms “include”, “comprise”, or any other variant thereof are intended to cover a non-exclusive inclusion, so that a process, a method, or a device that includes a list of elements not only includes those elements but also includes other elements which are not expressly listed, or further includes elements inherent to such a process, method, or device. Without more constraints, an element preceded by “includes at least one . . . ” does not preclude the presence of additional identical elements in the process, method, product, or device that includes the element.

In some embodiments, the online processing device described above can be implemented by a computer executable instruction executed by a computer, for example, a program module. Generally, the program module includes a routine, a program, an object, a component, a data structure, etc. for executing a specific task or implementing a specific abstract data type. Embodiments of this specification can also be practiced in distributed computing environments. In the distributed computing environments, tasks are performed by remote processing devices that are connected through a communication network. In the distributed computing environments, the program module can be located in local and remote computer storage media including storage devices.

The above description is merely example embodiments of this specification, and is not intended to limit this specification. A person skilled in the art can make various changes and variations to this specification. Any modification, equivalent replacement, improvement, etc. made without departing from the spirit and principle of this specification shall fall within the scope of the claims in this specification.

1. A method for online processing, comprising:
generating a surrender interaction webpage based on a surrender request submitted by a user terminal for an insurance product, and returning the surrender interaction webpage to the user terminal;
determining a prediction parameter for surrender quote prediction in insured-user data and policy data based on a product type of the insurance product; and
inputting the prediction parameter into a prediction model corresponding to the product type for surrender quote prediction, to obtain a surrender loss range and return the surrender loss range to the user terminal.

2. The method according to claim 1, wherein the method is applied to an interactive robot that performs surrender interaction processing on the insurance product; and
the surrender interaction webpage comprises a surrender interaction page generated by the interactive robot for the insurance product.

3. The method according to claim 1, further comprising:
detecting whether a processing institution stores a value calculation rule for the insurance product; and
in response to detecting that the processing institution does not store a value calculation rule for the insurance product, performing the determining the prediction parameter for surrender quote prediction in insured-user data and policy data based on the product type of the insurance product.

4. The method according to claim 3, further comprising:
in response to detecting that the processing institution stores a value calculation rule for the insurance product:
querying a surrender calculation parameter in the value calculation rule based on the insured-user data and the policy data; and
inputting the surrender calculation parameter into a surrender loss algorithm for surrender loss calculation, to obtain the surrender loss range.

5. The method according to claim 4, wherein the surrender loss calculation comprises:
calculating a first loss amount between an accumulated insurance amount and a policy value of a coverage period comprising a current time, and calculating a second loss amount between the accumulated insurance amount and a policy value of a previous coverage period; and
calculating ratios of the first loss amount and the second loss amount to the accumulated insurance amount as a loss upper limit and a loss lower limit of the surrender loss range.

6. The method according to claim 1, further comprising:
in response to the surrender request, calling, in an asynchronous manner, a surrender quote interface of the insurance product for surrender quote processing; and
generating a surrender confirmation webpage based on a surrender quote result returned through an interface call, and returning the surrender confirmation webpage to the user terminal after receiving a surrender confirmation instruction.

7. The method according to claim 1, wherein the determining the prediction parameter for surrender quote prediction in insured-user data and policy data based on the product type of the insurance product comprises:
reading each prediction parameter type in a prediction parameter table of the product type; and
querying a prediction parameter corresponding to each prediction parameter type in the insured-user data and the policy data.

8. The method according to claim 1, wherein the surrender interaction webpage comprises at least one of: an interaction question to be displayed, a question and answer interaction control, or a surrender control.

9. The method according to claim 8, wherein the surrender quote prediction is performed after a surrender quote question in the interaction question is triggered, or is performed after it is detected that question information submitted by the user terminal comprises a quote keyword; and
the surrender loss range is displayed in the question and answer interaction control after being returned to the user terminal.

10. The method according to claim 8, wherein the determining of the prediction parameter and the surrender quote prediction are performed after a surrender instruction generated by triggering the surrender control is received; and
the method further comprises:
generating a processing webpage that carries the surrender loss range, returning the processing webpage to the user terminal, and receiving a surrender confirmation instruction that is generated after the surrender control is triggered and that is configured on the processing webpage submitted by the user terminal.

11. The method according to claim 8, wherein after generating the surrender interaction webpage based on the surrender request submitted by the user terminal for the insurance product, and returning the surrender interaction webpage to the user terminal, the method further comprises:
inputting the interaction question submitted by the user terminal into a large language model for answer generation, to obtain an interaction answer; and
returning the interaction answer to the user terminal, to display the interaction answer in the question and answer interaction control.

12. A method for online processing, comprising:
generating a surrender request for an insurance product, and submitting the surrender request to a server;
displaying a surrender interaction webpage returned by the server for the insurance product; and
obtaining and displaying a surrender loss range that is obtained through surrender quote prediction and that is returned by the server, wherein the surrender quote prediction is performed by inputting a prediction parameter determined in user data and policy data of an insured user into a prediction model corresponding to a product type of the insurance product.

13. The method according to claim 12, wherein the surrender interaction webpage is generated by an interactive robot that performs surrender interaction processing on the insurance product and that is deployed in the server.

14. The method according to claim 12, further comprising:
receiving and displaying a surrender confirmation webpage that is generated based on a surrender quote result and that is returned by the server,
wherein the surrender quote result is obtained by calling, in an asynchronous manner, a surrender quote interface of the insurance product for surrender quote processing.

15. The method according to claim 12, wherein the surrender interaction webpage comprises at least one of: an interaction question to be displayed, a question and answer interaction control, or a surrender control.

16. The method according to claim 15, wherein the surrender loss range is displayed in the question and answer interaction control; and
the surrender quote prediction is performed after a surrender quote question in the interaction question is triggered, or is performed after it is detected that question information comprises a quote keyword.

17. The method according to claim 15, further comprising:
receiving and displaying a processing webpage that carries the surrender loss range and that is returned by the server; and
generating a surrender confirmation instruction after the surrender control configured on the processing webpage is triggered, and submitting the surrender confirmation instruction to the server.

18. The method according to claim 12, further comprising:
obtaining an interaction question input through a question and answer interaction control, and submitting the interaction question to the server; and
displaying, in the question and answer interaction control, an interaction answer returned by the server, wherein the interaction answer is obtained by inputting the interaction question into a large language model for answer generation.

19. A device for online processing, comprising:
a processor; and
a storage storing computer-executable instructions,
wherein the processor is configured to:
generate a surrender interaction webpage based on a surrender request submitted by a user terminal for an insurance product, and return the surrender interaction page to the user terminal;
determine a prediction parameter for surrender quote prediction in insured-user data and policy data based on a product type of the insurance product; and
input the prediction parameter into a prediction model corresponding to the product type for surrender quote prediction, to obtain a surrender loss range and return the surrender loss range to the user terminal.

20. A device for online processing, comprising:
a processor; and
a storage storing computer-executable instructions,
wherein the processor is configured to perform the method according to claim 12.
